(19) United States
(12) Patent Application Publication
(10) Pub. No.: US 2019/0316885 A1
(43) Pub. Date: Oct. 17, 2019

(54) Mobile Shooting Range

(71) Applicant: Mobile Range Technologies, LLC, Wichita Falls, TX (US)

(72) Inventors: Scott Hinton, Wichita Falls, TX (US); Timothy McAdoo, Wichita Falls, TX (US)

(21) Appl. No.: 16/252,555

(22) Filed: Jan. 18, 2019

Related U.S. Application Data
(60) Provisional application No. 62/619,037, filed on Jan. 18, 2018.

(51) Int. Cl. F41J 11/00; F41J 13/00; F41J 9/00; F24F 1/0284

(52) U.S. Cl. CPC F41J 11/00; F41J 13/00; B60P 3/025; F24F 1/0284; F41J 9/00

(57) ABSTRACT

A mobile gun range system having a gun range positioned in a container attached to a mobile platform such as a semi-trailer. The mobile system includes a self-contained air handling system, automated target retrieval system, and projection system. The mobile unit can include a generator and fuel storage.

### CROSS-REFERENCE TO RELATED APPLICATIONS

This is a U.S. Non-Provisional application claiming priority to U.S. Provisional Application No. 62/619,037, filed Jan. 18, 2018.

### TECHNICAL FIELD

The present disclosure is in the technical field of indoor shooting ranges and, more particularly, to a shooting range positioned in a container as part of or on a mobile platform.

### BACKGROUND

Indoor shooting ranges are known in the art and have the necessary safety and ventilation systems to accommodate the discharge of firearms indoors. However, such indoor ranges are stationary; that is, they are located within a building.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a perspective view of a container-based mobile shooting range according to aspects of the present disclosure;

FIG. 2 is a side view of the mobile range unit of FIG. 1;

FIG. 3 is a side cross-sectional view of the mobile range unit of FIG. 1;

FIG. 4 is a top cross-sectional view of the mobile range unit of FIG. 1;

FIG. 5 is a second side cross-sectional view of the mobile range unit of FIG. 1;

FIG. 6 is a side view of an exemplary bullet trap assembly according to aspects of the invention;

FIG. 7 is a top view of an exemplary target arm according to aspects of the disclosure; and

FIG. 8 is a side view of the target arm of FIG. 7.

### DETAILED DESCRIPTION OF PREFERRED EMBODIMENTS

The present inventions and disclosures are described by reference to drawings showing one or more examples of how the inventions can be made and used. In these drawings, reference characters are used throughout the several views to indicate like or corresponding parts. In the description which follows, like or corresponding parts are marked throughout the specification and drawings with the same reference numerals, respectively. The drawings are not to scale and proportions of certain parts have been exaggerated to better illustrate details and features. Directional terms, such as “up,” “down,” “upward,” downward,” and the like, are made with reference to the accompanying figures unless otherwise indicated and are not to be taken as limiting the embodiments in their orientations of use.

A mobile shooting range unit is provided having safety features, an air handling system, a control system, multiple shooting booths with training features, firearms simulation systems, scenario-based target movement system, and projector system. Described herein are embodiments and features of embodiments of the disclosure which are non-limiting.

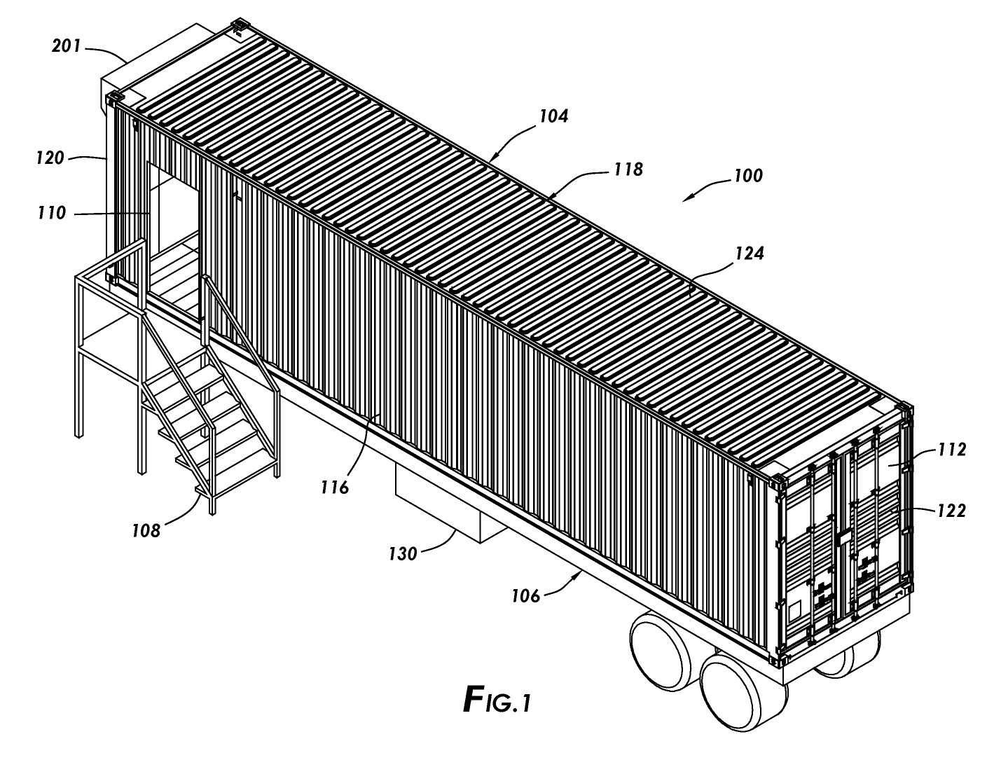

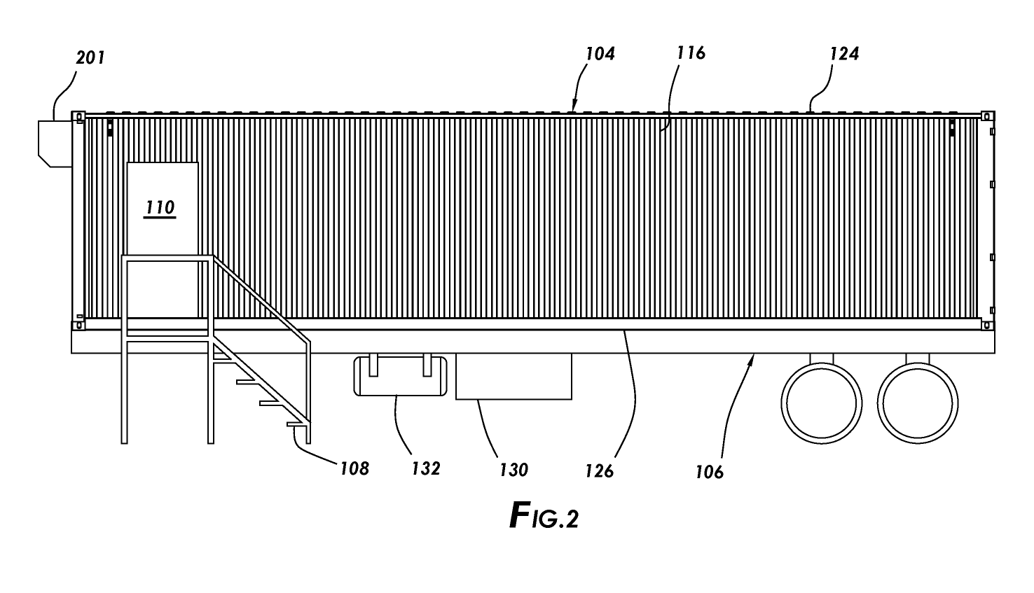

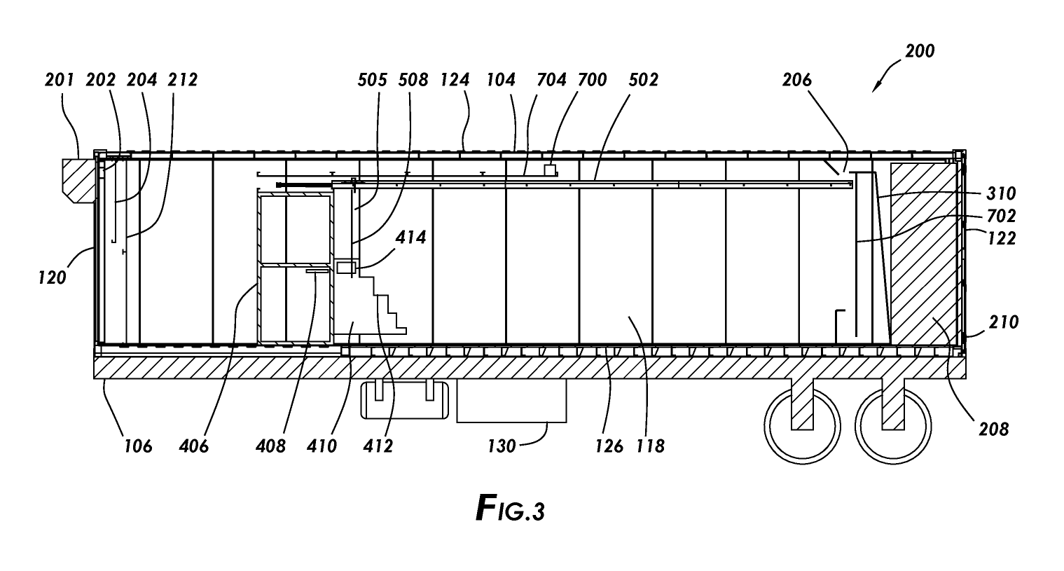

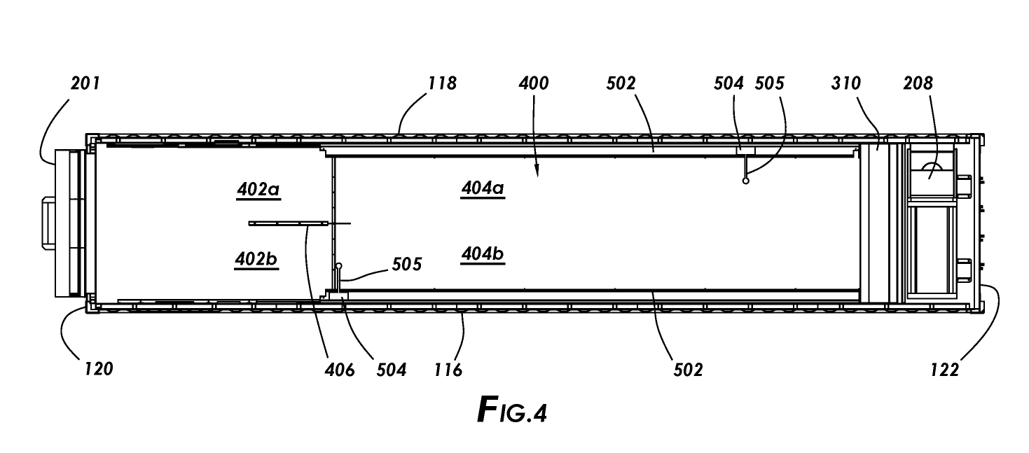

FIG. 1 is an orthogonal view of an exemplary mobile range unit according to aspects of the disclosure. FIG. 2 is a side view of the mobile range unit of FIG. 1. FIG. 3 is a side cross-sectional view of the mobile range unit of FIG. 1. FIG. 4 is a top cross-sectional view of the mobile range unit of FIG. 1. FIG. 5 is a second side cross-sectional view of the mobile range unit of FIG. 1. These figures will be discussed together.

An exemplary mobile range unit 100 is provided having a container 104 positioned on a mobile platform 102. For example, the container can be a shipping container mounted, removably or fixedly, on a tractor trailer 106. Alternately, the mobile range unit 100 can comprise a wheeled semi-trailer defining a walled compartment, for example. As used herein, “container” refers to the walled structure within which the firing range is positioned, where, without limitation, the structure can be a storage or shipping container, removable from or fixed on a mobile platform, or a trailer having a walled compartment. In preferred embodiments, the mobile range unit is self-contained, requiring no further structures for safe and easy use.

Access stairs 108 or a ladder are provided to an exterior door 110 of the mobile range unit, seen open in FIG. 1. The stairs 108 in some embodiments fold-up, are removable or can otherwise be stowed for travel of the unit. For example, the stairs can be removed and stowed in a suitable compartment defined in the interior of the container or to a suitable frame on the exterior of the container. Additional doors 112 can be provided to the interior of the container, for example, to allow access to interior spaces, structures and machinery. For purposes of discussion, the container 104 includes opposed side walls 116 and 118, an up-range end wall 120, a down-range end wall 122, a roof 124 and a floor 126. Note that the up and down-range end walls can be in opposite positions of those shown. The figures present a range oriented such that up-range is above the front of the trailer (where the trailer is attached to a semi-rig, for example) and down-range is towards the end of the trailer. In alternate embodiments, the orientation of the range or ranges can be reversed.

The mobile range unit, in some embodiments, includes an electrical generator 130 and a stored fuel system 132 to supply electrical power. Alternately, the unit can be powered externally at an inlet, for example, from a 220V AC power source.

An air handling system 200 provides for continuous supply of fresh air from outside the container to the interior of the container, and reduces inhalation and stagnation of dangerous fumes and particulate associated with the discharge of firearms, such as lead. The air handling system 200, in some embodiments, includes one or more intake air filter units 201 for filtering air which is drawn into the container, an air inlet 202 for providing access of air from exterior to interior the container, one or more air diverters 204 for directing air flow within the container, an air passageway 206 providing air flow over the top of the bullet trap 310, an air filtration system 208 for treating air prior to discharge from the container, and an air outlet 210 for discharging air from interior the container to exterior the container.

The intake air filter unit 201 can be mounted to the interior or exterior of the container. The intake air filter unit 201, in an embodiment, does not include fans or other forced air flow mechanisms. Air enters the container by way of one or more air inlets 202. Filters can be used in association with the air intake unit and inlet. Air diverters 204 can be used to control the direction of air flow within the container. An exemplary air diverter 204 is seen in illustrated but additional diverters can be used as desired. In an embodiment, a perforated screen 212 is provided to prevent user access to the air control unit, filters, inlet, etc.

An air control system 208 is preferably provided and can include fans, air filtration systems, such as a HEPA air filtration system, etc. In a preferred embodiment, the air control system 208 is positioned at the down-stream end of the air flow through the container. That is, the air control system 208 is adjacent the air outlet 210 to the container. Fans of the control system 208 are positioned near the outlet 210 and directed to force air out the outlet 210, thereby producing a mild vacuum in the container. The vacuum pulls air through the inlet 202. Such an arrangement prevents or reduces contaminants and odors from escaping through openings in the container, such as cracks, open doors, etc.

The HEPA air filtration system can be 99 percent or more effective at removing airborne particles, for example. Further, in some embodiments a carbon filter is employed to remove the gunpowder smell. In some embodiments, the air filtration system meets or exceeds all legally or statutorily required standards. In some embodiments, the air returned to the environment outside the container is actually cleaner than the air taken into the container. In some embodiments, the interior air is not recycled, but rather new air is brought in and treated air is vented out of the container. These air handling systems improve the safety and experience of the user in the container. In some embodiments, an air quality monitor 220 is provided in the container for measuring the air quality or determining when air filters in the filtration system need to be replaced. Such monitors are known in the art.

The air handling system of the disclosed container gun range allows the container (or container and mobile platform to be placed in a building without contaminating or releasing odors into the air of the building. This allows the container, with or without the mobile platform, to be positioned in the interior of a large building, such as a convention center, and used without detrimental effects to the air in the building.

Further, the air handling system elements are mounted to the container or in the container. The air handling units are not, for example, mounted to the mobile platform. Other mobile units mount air handling system elements under the mobile platform, resulting in critical clearance issues when the mobile platform is driven over uneven terrain, speed bumps, ramps and the like.

The air is directed largely from up-range to down-range. That is, air flow is generally one-way. This forces discharged smoke and contaminants down-range, away from the shooter. As shown, the exemplary air flow enters at the up-range end of the container, drawn into the container at the air filter unit 201 and through the air inlet 202. Air is diverted as desired, such as by the flow diverter 204. Air flows generally from behind the shooter to the down-range end of the shooting range. The air filtration system 208 is preferably positioned adjacent the down-range end wall 122 of the container, behind the bullet trap assembly 310, although other placements are possible. The air filtration unit includes one or more fans which force air flow through the container. Air exits the container through the air filtration system 208 and filters therein, and then through air outlet 210, which can direct air through the end wall 122 as shown, or through the other walls, roof or floor, as desired.

Air flow passages can be provided through or around projection screens and the spent ammunition trap system. Air flow passageway 206 will be described in detail below.

In an alternate embodiment, air conditioning (cooling and heating) is also supplied using an appropriate air conditioning unit. As such units employ fans to blow treated air into the container, it is necessary to balance air inflow and outflow to create the mild vacuum effect discussed above.

Safety is a primary concern in the mobile range unit. Therefore the side walls 116 and 118, the floor 126 and the ceiling 124 are made of or lined with bullet proof material 300. In some embodiments, the walls, floor and ceiling are made of or have panels of bullet proof material, such as AR500. In some embodiments, the bullet proof lining can be a non-metallic material, such as ballistic rubber. The materials can be installed by fastener, adhesive, or any other method available. Bullet proof materials are known in the art and will be understood by a person of experience in the art. The bullet proofing should run at least the length of the range or ranges and/or stalls. In an embodiment, the up-range wall 120 is also covered by or made of bullet proof materials. In an embodiment, the down-range wall 122 is bullet-proof.

The bullet trap 310 is made of bullet-proof material. Preferably the trap elements are made of AR500 alloy or equivalents as are known in the art. AR500 and other alloys are commercially available, for example, from Chapel Steel, Leeco Steel, or Titus Steel. AR500 is an abrasion resistant steel plate for high wear applications, such as concrete, aggregate and materials handling, mining, and tractor-trailer manufacture, and for high impact stress resistance, such as for body armor and ballistic plate. AR500 steel is heat treated for through-hardening and exhibits a typical Brinell hardness number of 460 or higher. The entire unit can be lined to prevent discharged projectiles from exiting the unit. In an embodiment, the walls, ceiling and floor are lined with ballistic rubber of sufficient thickness. Further a metal, plastic or other material liner can be provided at the walls, ceiling and floor for the same purpose. One or more liners can be used in conjunction. Liners and bullet-proof panels can be used in conjunction.

As best seen in FIG. 4, the mobile range unit has a range system 400. The range system 400 can include two (or more), parallel, side-by-side stalls 402a-b and ranges 404a-b. Alternately, a single range can be used. Where multiple ranges are included, the shooting stalls can be separated by a partition 406, wall, partial wall or the like. A shooter stands at a shooting stall 402 defined at or near one end of the unit and fires down-range towards the other end of the unit.

A shelf or movable shelf 408 can be provided for a shooter and can be mounted to a side wall 116 or 118, or to the partition 406, for example. In an embodiment, a stowable shelf 408 is pivotally mounted to swing out of the way when not in use. The shelf 408 can be flush-mounted into the side wall, held in a closed position by a latch (e.g., a simple lock-pin), and movable to an open position providing a working surface for the shooter to place his weapons, ammunition and other supplies. When in the closed position, the folding shelf is out of the way and does not interfere with use of the range, movement along the range, viewing of projections, etc.

A movable training wall or panel 410 is optionally provided for use by a shooter. The training wall 410, in an embodiment, pivots or otherwise moves from a closed position wherein it is out of the way (e.g., flush-mounted against a side wall or partition) to an open position for use by the shooter during use of the range. The training wall 410 in some embodiments provides a varied profile 412, such as seen in FIG. 3, to provide training of weapon discharge and use of cover at various heights, behind varying shapes of cover, etc. Similarly, the training wall can employ one or more cut-outs 414 or cut-ways for training purposes. Cut-out 414, seen in FIG. 3, is a rectangular opening defined in the training wall for viewing, aiming, and/or shooting through.

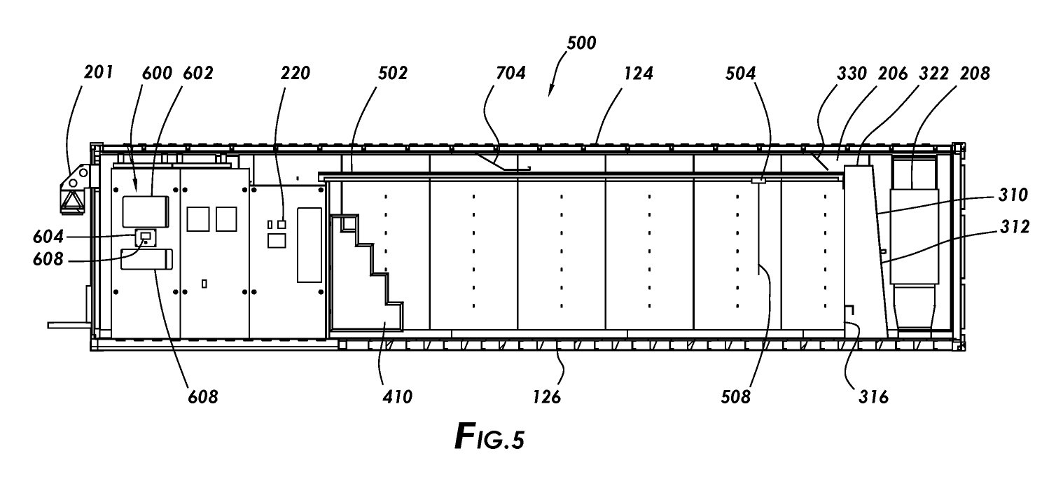

FIG. 6 is a side view of an exemplary bullet trap assembly and deflector according to aspects of the invention. At the down-range end of the range is a bullet trap assembly 310. The bullet trap assembly, as the name implies, is designed to stop fired projectiles safely without ricochets heading back up the range. In an embodiment the bullet trap assembly 310 comprises a generally vertical primary wall 312 extending substantially the height and width of the range, a generally horizontal bottom wall 314 extending up-range from the vertical wall 312, and a generally vertical trap wall 316 extending upwards a fraction of the height of the vertical wall 312. Note that the primary wall 312 does not extend the entire height of the container in the embodiment shown to allow for air passage over the wall 312 as will be explained. A web 318 extends down-range from the top edge of the trap wall 316. In some embodiments, a generally vertical flange 320 extends down from the rear edge of the web 318. Tests were performed on various configurations of the bullet trap assembly 310. It was found that the use of web 318 and flange 320 resulted in more successful trapping of fired projectiles and pieces thereof than designs without the web and flange.

Dimensions are provided for a non-limiting exemplary embodiment of the bullet trap assembly. In the example, the generally vertical primary wall 312 has a height, H, for example, about 95 inches, which is slightly less than the interior height of the container. This leaves a gap above the primary trap wall 312 of about 5 inches for an air flow passageway 206 over the trap assembly 310 and primary trap wall 312. The bottom wall 314 is approximately 24 inches in length, L. The bottom trap wall 314 is preferably horizontal, parallel to the floor, and positioned on the floor of the container. The primary trap wall 312 is preferably slightly angled, defining an acute angle α with respect to the horizontal, as shown. In an embodiment, the acute angle α is approximately 85 degrees. In some embodiments the angle α is between about 75 degrees and 88 degrees. The term “vertical” and “generally vertical” with respect to the primary vertical wall 312 encompasses walls angled at these degrees.

Further in the example shown, the trap wall 316 is generally vertical and extends a height, h, approximately 18 inches upwards from the bottom trap wall 314. The trap web 318 is generally horizontal and approximately 4 to 5 inches in length, l. In the embodiment, the trap web 318 is parallel to the floor and bottom wall 314. The trap flange 320 is approximately 4 to 5 inches in height, t, and is generally vertical. In some embodiments, a generally horizontal upper trap wall 322 is provided, extending up-range from the vertical wall 312. In the example shown, the upper wall 322 extends a distance, d, approximately 15 inches.

The trap assembly 310 can be positioned at or near the down-range wall 122 of the unit. In the embodiment shown, the primary trap wall 312 is positioned spaced from the down-range wall 122 to allow an area for the air filtration system 208. The bottom trap wall 314 can be flush with, mounted on or spaced above the floor 126.

An air passageway 206 is provided to allow air flow past the bullet trap assembly 310. In the embodiment shown, the air passageway 206 direct air over the top of the trap assembly 310. In some embodiments, the air passageway is bounded by the ceiling 124 and the upper reaches of the trap assembly 310 as shown. Any passageway past the bullet trap assembly presents an issue with respect to potential projectile travel along the passageway. Consequently, in some embodiments, a bullet deflector 330 is provided to protect against projectile travel through the passageway 206.

An exemplary deflector 330 abuts and is attached to the ceiling 124, extending downward at an angle with respect to the ceiling. In an embodiment, the angle is approximately 45 degrees. The deflector 330 extends downward from the ceiling 124 a greater distance than the gap defined between the ceiling 124 and the upper end of the trap assembly 310. That is, the vertical extent of the deflector 330 overlaps the vertical extent of the trap assembly 310 (or primary trap wall 312) an overlap distance, p. In the exemplary embodiment shown, the deflector 330 has a length, e, of approximately 14 inches and extends approximately 10 inches downward from the ceiling. The gap between the upper end of the primary trap wall 312 and ceiling is approximately 5 to 6 inches. Similarly, the gap between the upper trap wall 322 and the ceiling is approximately 5 to 6 inches. Thus, the vertical extent of the deflector 322 overlaps the vertical extent of the primary trap wall 312 by the overlap distance, p, of approximately 4 to 5 inches. The deflector 322 is spaced up-range from the upper wall 322 by a distance, D, of approximately 10 inches.

The deflector and bullet trap are positioned such that no projectile (travelling a basically straight path) can be fired from the stall 402 and enter the air passageway 206 over the primary trap wall 312. Stated another way, the deflector and bullet trap are dimensioned and positioned such that no projectile fired from the stall 402 can pass over the bullet trap 310. Any projectile will strike either the deflector 330 or the trap assembly 310. In some embodiments, a generally vertical opening is defined between the deflector 330 and the upper trap wall 322 through which air must pass to flow over the trap system 310, as shown.

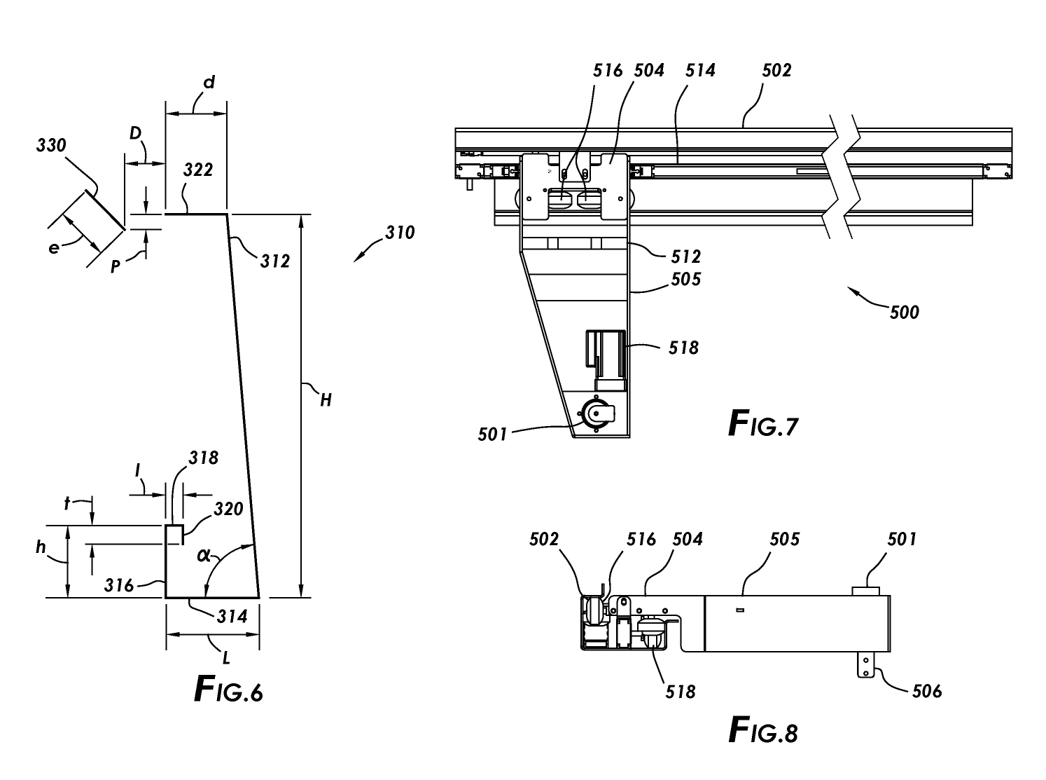

An automated target manipulation system 500 is provided for each range in the container. The target manipulation system can be seen in FIGS. 3-8. FIG. 7 is a top view of an exemplary target arm according to aspects of the disclosure. FIG. 8 is a side view of the target arm of FIG. 7. The target manipulation system 500, in some embodiments, includes a linear track or rail 502 extending along the range 404, a carriage 504 movably mounted to the track 502, a target arm 505 attached to the carriage 504, a rotary target support 506 for supporting a removable target 508, and necessary motors 510 for automatically operating the system. The target manipulation system 500 is seen and described for a range 404. It is understood that where multiple ranges are positioned in the container that each such range can have an independent target manipulation system.

A target 508, such as a paper target, is removably held, such as by a clip, to the rotary target support 506. The rotary target support 506 is rotatable, for example by a rotary motor 501, thereby rotating the target 508. For example, the rotary target support can rotate through 90 degrees, through 180 degrees, or up to 360 degrees. Rotation of the target through 90 degrees allows movement of the target from a firing position, facing the shooter, to a non-firing position, wherein the target edge faces the shooter. Rotation through 180 degrees allows for “shoot” and “don't shoot” faces of the target to face the shooter, for example. In an embodiment, a rotation through 180 degrees is completed in about 500 milliseconds.

The automated target manipulation system can position the target in various orientations, including during a shooting session. For example, the system can position the target at a blade position, wherein the target is positioned so that the shooter sees the edge of the paper. This can be considered the 90 degree position. The target can be turned 90° from the blade position to have the front or back face of the target face the shooter. These can be considered the zero degree and 180 degree positions. For easier fast travel down-range, the target can be positioned in the blade position. Similarly, for the beginning of a “good guy-bad guy” or “friend or foe” scenario, the target is in the blade position so the shooter cannot identify the images on the front or rear faces of the target. The target is then rotated to the 0 or 180 position for identification and action by the shooter.

The target 508 is movable forward and back along the range 404 between an up-range retrieval position proximate the stall 402 (e.g., within reach of a user in the stall) and one or more down-range positions. In an embodiment, the linear track 502, rail, or the like, is mounted to a wall 116 or 118 or ceiling 124 of the container. In an exemplary embodiment, the linear track 502 is mounted on a side wall 116 or 118 of the container so as to be less likely to be hit by errant projectiles. Further, the track can be mounted at shoulder or above height to place the rail out of the typical line of fire. Where two ranges 404a-b are employed, two opposed linear tracks are mounted on opposing side walls 116 and 118.

The target 508 is movable backwards and forwards along the range. The rotary target support 506 is attached to the target arm 505, which is mounted to the carriage 504. The carriage 504 is movable along the linear track 502, thereby moving the arm 505, support 506, and target 508. For example, the target arm 505 can be mounted to a driven carriage 504 movable on the track 502, mounted to an endless chain or belt 514 which defines or moves along the track 502, mounted on a linear actuator or similar mechanisms known in the art. Further, battery powered and wireless target control is commercially available and can be employed. In the embodiment shown, a carriage 504, having wheels 516, for engaging the track 502, is driven along the track by a carriage motor 518 which acts upon a belt 514. Alternately, the motor 518 could drive the wheels 516, thereby moving the carriage 504 along the track 502. Alternately, a motor can drive the belt or chain, to which the carriage is attached. Other arrangements will be apparent to those of skill in the art. The motors and actuators are preferably electric.

In an embodiment, the target arm 505 is movable out of the way of the shooter. For example, the arm 505 can pivotally move about a vertical or horizontal hinge 512 to a stowed position out of the line of fire, for example, to a position flush with (or parallel to) the side wall or ceiling. The arm 505 can be mounted on a hinge 512 and rotated between a live position (with the target held in the line of fire) and a stowed position (with the target held flush to the wall, for example). Alternately, the target carriage 504 can be moved along the rail 502 to a stowed position wherein the target arm 505 is stowed in a position above the head of the shooter or behind the shooter. This places the arm out of the way for training using projected images, for example.

The target manipulation system is automated and operably controlled by a control system 600 comprising software, hardware, and firmware, as needed, to control motion of the system and a target attached thereto. For example, a user can have access to a computer or controller 602 for controlling of movement of the target. The controller 602 can simply be a few buttons to control movement of the target up and down range, or to rotate the target. In another example, the controller is a general purpose computer having a screen, an input device (e.g., keypad) 608, and operable to run software 604 stored on a non-transitory computer readable media 606. The software provides selectable scenarios, user or teacher selected, which, upon activation, will automatically move the target through a series of manipulations (e.g., forward and backward motion, at various speeds, stops, rotations of the target, etc.). For example, a program selection may provide a “friend-foe” determination scenario in which one side of the target is designated “friend” and the other “foe.” The control system would rotate the target between an edge-on neutral view to a position displaying either the friend or foe view. The shooter would react accordingly. Other scenarios can provide for movement of the target (e.g., a potential attacker) toward and/or away from the shooter, etc. Scenarios can also provide for a series of pre-set tasks as part of a training program. Scenarios can provide automated rest times, for example, to allow for reading of display of instructions, reloading of weapons, etc.

A projection system 700 is provided for projecting and displaying stationary and moving images, for example instructions or training scenarios onto a screen or curtain 702 at the down-range end of the range 404. The projector 700 can be mounted to the ceiling 124, positioned on a shelf 704 running along the unit, etc. The projector 700 is protected from damage in an embodiment by a bullet-proof shelf 704. The projector can be controlled by the controller, computer system, software programs, etc. The projector 700 can be operated in conjunction and coordination with the target manipulation system.

For scenario simulations, a shoot-through projection screen 702 can be provided at or near the down-range end of the range. The screen 702 provides a surface on which the projected images appear. The screen 702 can also be a “shoot-through” material. For example, the screen can be made of self-healing rubber, silicon, plastic or other material. The screen 702 is replaceable. Such material screens are available commercially, for example, Linatex® Target Backing from Weir Minerals. In an alternate embodiment, the primary wall 312 of the bullet trap can operate as a screen for projections from the projector.

While the description above is drawn primarily to a mobile range unit, some of the features and systems described are also applicable to stationary, indoor gun ranges. In particular, the air flow system can be used in a stationary range to direct air flow, eliminate contaminants and odors from the air, cycle air from exterior the range (rather than rely on recycled air from interior the building), create a mild vacuum in the building to further direct air flow, etc. Similarly, the target retrieval system can be placed in a stationary building. The wall-mounted retrieval rails or tracks can be mounted to a building interior wall to remove the track from typical line of fire, for example. The bullet trap system also can be employed in a stationary building.

The words or terms used herein have their plain, ordinary meaning in the field of this disclosure, except to the extent explicitly and clearly defined in this disclosure or unless the specific context otherwise requires a different meaning. If there is any conflict in the usages of a word or term in this disclosure and one or more patent(s) or other documents that may be incorporated by reference, the definitions that are consistent with this specification should be adopted.

The words “comprising,” “containing,” “including,” “having,” and all grammatical variations thereof are intended to have an open, non-limiting meaning. For example, a composition comprising a component does not exclude it from having additional components, an apparatus comprising a part does not exclude it from having additional parts, and a method having a step does not exclude it having additional steps. When such terms are used, the compositions, apparatuses, and methods that “consist essentially of” or “consist of” the specified components, parts, and steps are specifically included and disclosed. The indefinite articles “a” or “an” mean one or more than one of the component, part, or step that the article introduces. The terms “and,” “or,” and “and/or” shall be read in the least restrictive sense possible. Each numerical value should be read once as modified by the term “about” (unless already expressly so modified), and then read again as not so modified, unless otherwise indicated in context.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

While the foregoing written description of the disclosure enables one of ordinary skill to make and use the embodiments discussed, those of ordinary skill will understand and appreciate the existence of variations, combinations, and equivalents of the specific embodiments, methods, and examples herein. The invention should therefore not be limited by the above described embodiments, methods, and examples. While this disclosure has been described with reference to illustrative embodiments, this description is not intended to be construed in a limiting sense. Various modifications and combinations of the illustrative embodiments as well as other embodiments of the invention will be apparent to persons skilled in the art upon reference to the description. It is, therefore, intended that the appended claims encompass any such modifications or embodiments. The particular embodiments disclosed above are illustrative only, as the present disclosure may be modified and practiced in different but equivalent manners apparent to those skilled in the art having the benefit of the teachings herein. It is, therefore, evident that the particular illustrative embodiments disclosed above may be altered or modified and all such variations are considered within the scope of the present disclosure. The various elements or steps according to the disclosed elements or steps can be combined advantageously or practiced together in various combinations or sub-combinations of elements or sequences of steps to increase the efficiency and benefits that can be obtained from the disclosure. It will be appreciated that one or more of the above embodiments may be combined with one or more of the other embodiments, unless explicitly stated otherwise. The disclosure illustratively disclosed herein suitably may be practiced in the absence of any element or step that is not specifically disclosed or claimed. Furthermore, no limitations are intended to the details of construction, composition, design, or steps herein shown, other than as described in the claims.

It is claimed:

1. A mobile gun range unit comprising:
a walled container attached to a wheeled platform;
a shooting range positioned within the walled container;
a bullet trap assembly positioned at a down-range end of the shooting range;
an air handling system for controlling air flow through the container, the air handling system having an air inlet communicating air from the exterior to the interior of the container, an air outlet communicating air from the interior to the exterior of the container, an air passageway allowing air passage past the bullet trap assembly, and a fan for forcing movement of air into and out of the container and through the passageway.

2. The mobile gun range unit of claim 1, the fan positioned proximate the air outlet and forcing air through the air outlet, the fan creating a vacuum within the container.

3. The mobile gun range unit of claim 1, further comprising an air filtration assembly positioned proximate the air outlet, the air filtration assembly comprising one or more air filters for removing contaminants from the air prior to expulsion of the air to the environment.

4. The mobile gun range unit of claim 3, wherein the air filtration assembly comprises a HEPA filter system capable of cleansing over 99 percent of the contaminants from the air.

5. The mobile gun range unit of claim 4, further comprising at least one carbon filter for removing gunpowder odors from the air prior to expulsion to the environment.

6. The mobile gun range unit of claim 1, wherein the air passageway is positioned above the bullet trap assembly.

7. The mobile gun range unit of claim 6, wherein the bullet trap assembly comprises a bullet-proof, generally vertical wall, a gap between the generally vertical trap wall and a ceiling of the container, the wherein the air passageway defined between the generally vertical trap wall and the ceiling.

8. The mobile gun range unit of claim 7, the bullet trap further comprising a bullet-proof, generally horizontal upper trap wall extending up-range from the generally vertical trap wall, generally parallel to the ceiling of the container, and wherein the air passageway is defined between the generally horizontal upper trap wall and the ceiling.

9. The mobile gun range unit of claim 7, further comprising a bullet-proof deflector positioned at the ceiling of the container and extending downward into the container, the deflector positioned up-range from the generally vertical trap wall, the deflector preventing projectiles from entering the air passageway.

10. The mobile gun range unit of claim 1, wherein the container is removable from the mobile platform.

11. A mobile gun range unit comprising:
a walled container attached to a wheeled platform;
a shooting range positioned within the walled container;
a bullet trap assembly positioned at a down-range end of the shooting range, the bullet trap assembly comprising:
a bullet-proof, generally vertical primary wall extending across the container, a gap defined between the primary trap wall and a ceiling of the container;
a bullet-proof bottom trap wall extending up-range from the primary trap wall;
a bullet-proof generally vertical partial trap wall extending upwards from the bottom trap wall, the partial trap wall spaced apart from the primary trap wall and having a height less than the height of the primary trap wall; and
a bullet-proof web extending generally horizontally and down-range from an upper edge of the partial trap wall.

12. The mobile gun range unit of claim 1, wherein the bullet trap assembly further comprises a bullet-proof, generally vertical flange extending downwards from the down-range edge of the web.

13. The mobile gun range unit of claim 1, wherein the primary trap wall is angled such that the top of the primary wall is up-range from the bottom of the primary wall.

14. The mobile gun range unit of claim 13, wherein the primary trap wall is angled at approximately 85 degrees from the horizontal.

15. The mobile gun range unit of claim 13, wherein the primary trap wall is angled between 75 and 88 degrees from the horizontal.

16. The mobile gun range unit of claim 1, wherein the gap comprises an air flow passageway over the top of the bullet trap assembly.

17. The mobile gun range unit of claim 16, further comprising a bullet-proof deflector positioned at the ceiling of the container and extending downward into the container, the deflector positioned up-range from the primary trap wall, the deflector preventing projectiles from entering the air passageway.

18. The mobile gun range unit of claim 17, the bullet trap further comprising a bullet-proof, generally horizontal upper trap wall extending up-range from the primary trap wall, and wherein the air passageway is defined between the upper trap wall and the ceiling.

19. A mobile gun range unit comprising:
a walled container attached to a wheeled platform;
a shooting range positioned within the walled container;
a bullet trap assembly positioned at a down-range end of the shooting range;
an automated target retrieval assembly positioned in the container and having a linear track mounted to a side wall of the container, a carriage movable along the track and operable to releasably hold a target, the carriage movable between a position adjacent a shooter's stall at the up-range end of the range and various down-range positions.

20. The mobile gun range unit of claim 1, wherein the carriage further comprises a pivoting target arm pivotable between a target position extending into the center of the range and a stowed position folded adjacent the container side wall; the target arm further comprising an automated rotary target support for supporting and rotating the releasable target.
